(19) United States
(12) Patent Application Publication
(10) Pub. No.: US 2026/0329470 A1
(43) Pub. Date: Oct. 22, 2026

(54) MEMORY MANAGEMENT METHOD AND STORAGE DEVICE

(71) Applicant: Hefei Kaimeng Technology Co., Ltd., Anhui (CN)

(72) Inventors: Wenjun Chai, Anhui (CN); Qiao ZHU, Anhui (CN); Boyan Lu, Anhui (CN); Jianhua Sun, Anhui (CN); Shuo Wang, Anhui (CN)

(73) Assignee: Hefei Kaimeng Technology Co., Ltd., Anhui (CN)

(21) Appl. No.: 19/693,506

(22) Filed: May 31, 2026

(30) Foreign Application Priority Data
Jun. 26, 2025 (CN) 202510872326.1

(51) Int. Cl. G06F 3/06

(52) U.S. Cl. CPC G06F 3/0653; G06F 3/0604; G06F 3/0679

(57) ABSTRACT

Disclosed are a memory management method and a storage device. The method includes: monitoring a plurality of risk assessment indicators corresponding to a first physical unit; dynamically adjusting a risk level of the first physical unit according to the plurality of risk assessment indicators; and if the risk level is a second risk level, when reading data from the first physical unit, skipping performing a conventional read on the first physical unit, and directly performing a re-read operation on the first physical unit based on a re-read voltage, wherein the re-read voltage is different from a preset read voltage used for the conventional read.

### CROSS-REFERENCE TO RELATED APPLICATION

This application claims the priority benefit of China application serial no. 202510872326.1, filed on Jun. 26, 2025. The entirety of the above-mentioned patent application is hereby incorporated by reference herein and made a part of this specification.

### BACKGROUND

### Technical Field

The present disclosure relates to a storage technology, and more particularly, relates to a memory management method and a storage device.

### Related Art

NAND flash memory (hereinafter, “NAND Flash”) is a form of non-volatile memory widely employed in electronic devices, including, without limitation, memory cards, solid-state drives, and portable multimedia players. Solid-state drives (SSDs), as a novel storage medium, utilize NAND Flash as the data storage medium and have been widely deployed in, inter alia, personal computers, notebook computers, and servers, and are progressively supplanting mechanical hard disk drives to become the mainstream product in the storage field.

However, as the data density of the flash medium increases, data reliability degrades across successive technology generations, thereby necessitating more robust error-correction algorithms and a greater number of read-retry voltage levels. Moreover, multiple rereads and iterative error-correction procedures substantially prolong data read times, thereby materially impairing the read performance of NAND Flash.

Existing error-handling schemes predominantly focus on identifying an optimal read reference voltage for a given data page so as to minimize the number of rereads; however, such an approach results in significant waste of flash bandwidth.

### SUMMARY

The present disclosure provides a memory management method and a storage device, which may overcome the above problems, thereby improving the operational efficiency and stability of the storage device.

An embodiment of the present disclosure provides a memory management method for a storage device, wherein the storage device includes a memory module. The memory module includes a plurality of physical units. The memory management method includes: monitoring a plurality of risk assessment indicators corresponding to a first physical unit among the plurality of physical units; dynamically adjusting a risk level of the first physical unit according to the plurality of risk assessment indicators; and if the risk level is a second risk level, when reading data from the first physical unit, skipping performing a conventional read on the first physical unit, and directly performing a re-read operation on the first physical unit based on a re-read voltage, wherein the re-read voltage is different from a preset read voltage used for the conventional read.

An embodiment of the present disclosure further provides a storage device, which includes a connection interface, a memory module, and a memory controller. The connection interface is configured to connect to a host system. The memory controller is connected to the connection interface and the memory module. The memory module includes a plurality of physical units, and the memory controller is configured to: monitor a plurality of risk assessment indicators corresponding to a first physical unit among the plurality of physical units; dynamically adjust a risk level of the first physical unit according to the plurality of risk assessment indicators; and if the risk level is a second risk level, when reading data from the first physical unit, skip performing a conventional read on the first physical unit, and directly perform a re-read operation on the first physical unit based on a re-read voltage, wherein the re-read voltage is different from a preset read voltage used for the conventional read.

### BRIEF DESCRIPTION OF THE DRAWINGS

FIG. 1 is a schematic diagram of a data storage system according to an embodiment of the present disclosure.

FIG. 2 is a schematic diagram of a memory controller according to an embodiment of the present disclosure.

FIG. 3 is a schematic diagram of managing a memory module according to an embodiment of the present disclosure.

FIG. 4 is a schematic diagram of a physical management unit and a physical unit according to an embodiment of the present disclosure.

FIG. 5 is a schematic diagram of risk levels of different physical units according to an embodiment of the present disclosure.

FIG. 6 is a flowchart of a memory management method according to an embodiment of the present disclosure.

### DESCRIPTION OF THE EMBODIMENTS

Now, detailed reference will be made to exemplary embodiments of the present disclosure, with instances of the exemplary embodiments illustrated in the accompanying drawings. Wherever possible, the same element symbols are used in the drawings and descriptions to represent the same or similar parts.

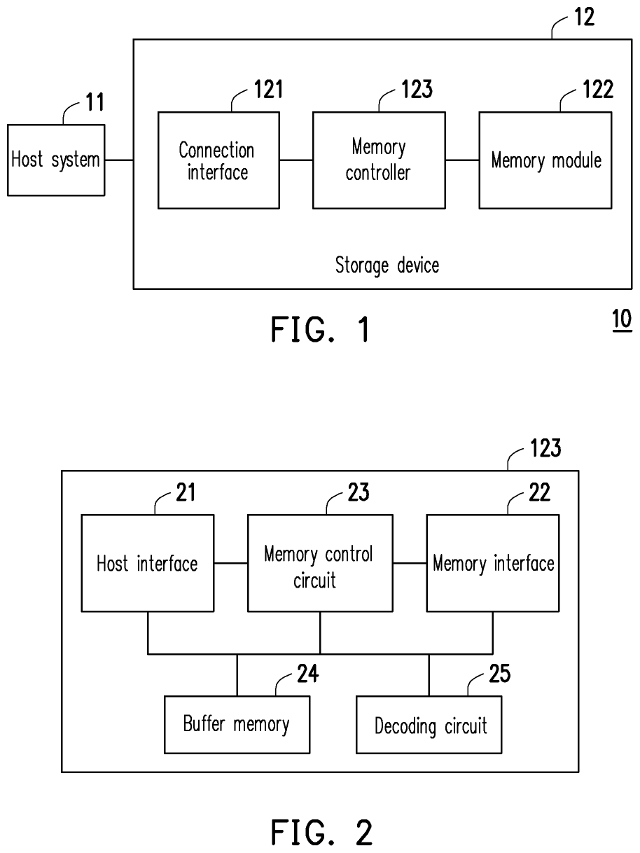

FIG. 1 is a schematic diagram of a data storage system according to an embodiment of the present disclosure. Referring to FIG. 1, the data storage system 10 includes a host system 11 and a storage device 12. The storage device 12 may be connected to the host system 11 and may be configured to store data from the host system 11. For example, the host system 11 may be a smartphone, a tablet computer, a notebook computer, a desktop computer, an industrial computer, a game console, a server, or a computer system disposed in a specific carrier (e.g., a vehicle, an aircraft, or a vessel), and the type of the host system 11 is not limited thereto. In addition, the storage device 12 may include a solid-state drive, a USB flash drive, a memory card, or other types of non-volatile storage devices.

The storage device 12 includes a connection interface 121, a memory module 122, and a memory controller 123. The connection interface 121 is configured to connect the storage device 12 to the host system 11. For example, the connection interface 121 may support embedded Multi-Media Card (eMMC), Universal Flash Storage (UFS), Peripheral Component Interconnect Express (PCI Express), Non-Volatile Memory Express (NVM express), Serial Advanced Technology Attachment (SATA), Universal Serial Bus (USB), or other types of connection interface standards. Therefore, the storage device 12 may communicate with the host system 11 via the connection interface 121 (e.g., exchange signals, instructions, and/or data).

The memory module 122 is configured to store data. For example, the memory module 122 may include one or more rewritable non-volatile memory modules. Each rewritable non-volatile memory module may include one or more memory cell arrays. The memory cells in the memory cell array store data in the form of voltage (also referred to as threshold voltage). For example, the memory module 122 may include Single Level Cell (SLC) NAND flash memory modules, Multi Level Cell (MLC) NAND flash memory modules, Triple Level Cell (TLC) NAND flash memory modules, Quad Level Cell (QLC) NAND flash memory modules, and/or other memory modules with the same or similar characteristics.

The memory controller 123 is connected to the connection interface 121 and the memory module 122. The memory controller 123 may be regarded as a control core of the storage device 12 and is configured to control the storage device 12. For example, the memory controller 123 may be configured to control or manage all or part of the operations of the storage device 12. For example, the memory controller 123 may include a Central Processing Unit (CPU), or other programmable general-purpose or special-purpose microprocessors, Digital Signal Processors (DSP), programmable controllers, Application Specific Integrated Circuits (ASIC), Programmable Logic Devices (PLD), or other similar devices or combinations of these devices. In an embodiment, the memory controller 123 may include a flash memory controller.

The memory controller 123 may send instruction sequences to the memory module 122 to access the memory module 122. For example, the memory controller 123 may send a write instruction sequence to the memory module 122 to instruct the memory module 122 to store data into specific memory cells. For example, the memory controller 123 may send a read instruction sequence to the memory module 122 to instruct the memory module 122 to read data from specific memory cells. For example, the memory controller 123 may send an erase instruction sequence to the memory module 122 to instruct the memory module 122 to erase data stored in specific memory cells. In an embodiment, erase is also referred to as erasure. In addition, the memory controller 123 may further send other types of instruction sequences to the memory module 122 to instruct the memory module 122 to perform other types of operations, which is not limited in the present disclosure. The memory module 122 may receive instruction sequences from the memory controller 123 and access the memory cells inside the memory module 122 according to the instruction sequences.

FIG. 2 is a schematic diagram of a memory controller according to an embodiment of the present disclosure. Please refer to FIG. 1 and FIG. 2, the memory controller 123 includes a host interface 21, a memory interface 22, and a memory control circuit 23. The host interface 21 is configured to connect to the host system 11 through the connection interface 121 to communicate with the host system 11. The memory interface 22 is configured to connect to the memory module 122 to access the memory module 122.

The memory control circuit 23 is connected to the host interface 21 and the memory interface 22. The memory control circuit 23 may be configured to control or manage all or part of the operations of the memory controller 123. For example, the memory control circuit 23 may communicate with the host system 11 through the host interface 21 and access the memory module 122 through the memory interface 22. For example, the memory control circuit 23 may include control circuits such as an embedded controller or a microcontroller. In the following embodiments, the description of the memory control circuit 23 is equivalent to the description of the memory controller 123.

In an embodiment, the memory controller 123 may further include a buffer memory 24. The buffer memory 24 is connected to the memory control circuit 23 and is configured to buffer data. For example, the buffer memory 24 may be configured to buffer instructions from the host system 11, data from the host system 11, and/or data from the memory module 122.

In an embodiment, the memory controller 123 may further include a decoding circuit 25. The decoding circuit 25 is connected to the memory control circuit 23 and is configured to perform encoding and decoding on data to ensure the correctness of the data. For example, the decoding circuit 25 may support various encoding/decoding algorithms such as Low Density Parity Check code (LDPC code), BCH code, Reed-Solomon code (RS code), Exclusive OR (XOR) code, and the like. In an embodiment, the memory controller 123 may further include various other types of circuit modules (such as power management circuits, etc.), which is not limited in the present disclosure.

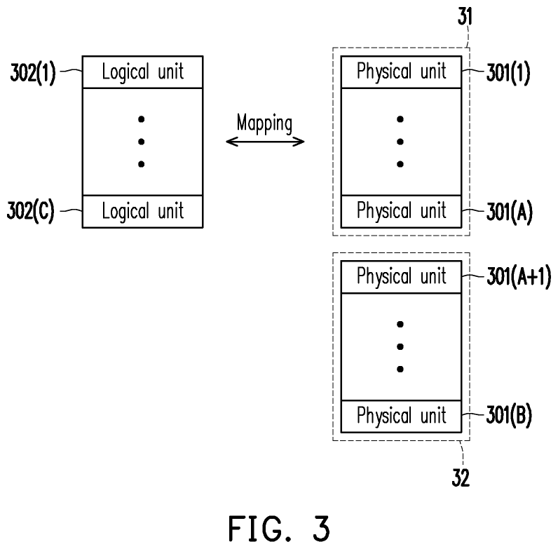

FIG. 3 is a schematic diagram illustrating management of a memory module according to an embodiment of the present disclosure. Please refer to FIG. 1 to FIG. 3, the memory module 122 includes a plurality of physical units 301(1) to 301(B). Each physical unit includes a plurality of memory cells and is configured to store data non-volatilely.

In an embodiment, a physical unit may include one or more physical programmable units. Programmable is also referred to as programming. A physical erase unit may include a plurality of physical programmable units. In an embodiment, a physical management unit may include one or more physical erase units. In an embodiment, a physical management unit is also referred to as a virtual block.

In an embodiment, a physical programmable unit may include a plurality of physical sectors. For example, a data capacity of one physical sector may be 512 bytes (B), and one physical programmable unit may include 32 physical sectors. However, the data capacity of one physical sector and/or the total number of physical sectors included in one physical programmable unit may both be adjusted according to practical requirements, which is not limited in the present disclosure. In an embodiment, one physical programmable unit may be regarded as one physical page. For example, a storage capacity of one physical programmable unit may be 16 kilobytes, and the present disclosure is not limited thereto.

In an embodiment, a physical programmable unit is a minimum unit for synchronously writing data in the memory module 122. For example, when performing a programming operation (also referred to as a write operation) on a physical programmable unit to write data to the physical programmable unit, a plurality of memory cells in the physical programmable unit may be synchronously programmed to store corresponding data. For example, when programming a physical programmable unit, a write voltage may be applied to the physical programmable unit to change a threshold voltage of at least a portion of the memory cells in the physical programmable unit. For example, a threshold voltage of a memory cell may reflect bit data stored in the memory cell.

In an embodiment, a plurality of physical programmable units in a physical erase unit may be synchronously erased. For example, when performing an erase operation on a physical erase unit, an erase voltage may be applied to the plurality of physical programmable units in the physical erase unit to change a threshold voltage of at least a portion of the memory cells in the physical programmable units. By performing an erase operation on a physical erase unit, the data stored in the physical erase unit may be erased. In an embodiment, a physical erase unit may be regarded as a physical block.

In an embodiment, the memory control circuit 23 may logically associate the physical units 301(1) to 301(A) and 301(A+1) to 301(B) with a data region 31 and a spare region 32, respectively. The physical units 301(1) to 301(A) in the data region 31 all store data (also referred to as user data) from the host system 11. For example, any one of the physical units in the data region 31 may store valid data and/or invalid data. In addition, the physical units 301(A+1) to 301(B) in the spare region 32 do not store any data (e.g., valid data).

In an embodiment, if a specific physical unit does not store valid data, the physical unit may be associated with the spare region 32. In addition, the physical units in the spare region 32 may be erased to remove the data from the physical units. In an embodiment, the physical units in the spare region 32 are also referred to as free physical units. In an embodiment, the spare region 32 is also referred to as a free pool.

In an embodiment, when data is to be stored, the memory control circuit 23 may select one or more physical units from the spare region 32 and instruct the memory module 122 to store the data into the selected physical units. After storing the data into the physical units, the physical units may be associated with the data region 31. In other words, one or more physical units may be used alternately between the data region 31 and the spare region 32.

In an embodiment, the memory control circuit 23 may be provided with a plurality of logical units 302(1) to 302(C) to map the physical units (i.e., the physical units 301(1) to 301(A)) in the data region 31. For example, one logical unit may correspond to one logical block address (LBA) or other logical management unit. One logical unit may be mapped to one or more physical units.

In an embodiment, if a specific physical unit is currently mapped by any logical unit, the memory control circuit 23 may determine that the data currently stored in the physical unit includes valid data. Conversely, if a specific physical unit is currently not mapped by any logical unit, the memory control circuit 23 may determine that the physical unit does not currently store any valid data.

In an embodiment, the memory control circuit 23 may record a mapping relationship between logical units and physical units in at least one management table (also referred to as a logical-to-physical mapping table). In an embodiment, the memory control circuit 23 may instruct the memory module 122 to perform operations such as data reading, writing, or erasing according to the information in the management table (i.e., the logical-to-physical mapping table).

In an embodiment, the memory control circuit 23 may monitor a plurality of risk assessment indicators corresponding to a specific physical unit (also referred to as a first physical unit) in the memory module 122. For example, the first physical unit may be one of the physical units 301(1) to 301(B) in FIG. 3. The plurality of risk assessment indicators may be configured to assess and/or reflect the health of the first physical unit. In an embodiment, the memory control circuit 23 may store the monitored plurality of risk assessment indicators corresponding to the first physical unit in the spare region of the first physical unit based on a preset data format.

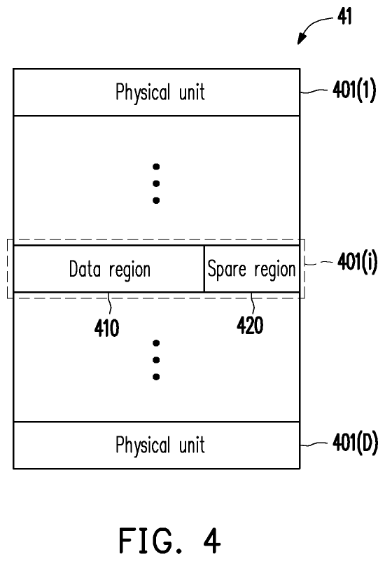

FIG. 4 is a schematic diagram of a physical management unit and physical units according to an embodiment of the present disclosure. Please refer to FIG. 4, assume that the memory module 122 includes a physical management unit 41. The physical management unit 41 includes a plurality of physical units 401(1) to 401(D). In addition, assume that the first physical unit is a physical unit 401(i), i is an integer between 1 and D.

In an embodiment, the physical unit 401(i) includes a data region 410 and a spare region 420. The data region 410 is dedicated to storing user data. For example, the data region 410 is dedicated to storing user data from the host system 11. In addition, the spare region 420 may be configured to store error-correction codes, logical-to-physical mapping information, and/or other types of management data. The error-correction codes are configured to correct the data currently stored in the data region 410. For example, the decoding circuit 25 may correct errors (i.e., error bits) in the data currently stored in the data region 410 based on the error-correction codes. The logical-to-physical mapping information reflects a mapping relationship between the physical unit 401(i) and at least one logical unit (also referred to as a first logical unit). For example, the first logical unit may be one of the logical units 302(1) to 302(C) in FIG. 3.

In an embodiment, the memory control circuit 23 may store the monitored plurality of risk assessment indicators corresponding to the physical unit 401(i) in the spare region 420 of the physical unit 401(i) based on a preset data format. For example, the preset data format may store one type of risk assessment indicator based on a data length of one byte. Therefore, assuming that the total number of the plurality of risk assessment indicators is 8 (i.e., 8 types of risk assessment indicators), the plurality of risk assessment indicators may be stored in the spare region 420 through a total data length of 8 bytes. However, the preset data format may also be adjusted according to practical requirements. Thereafter, when needed, the memory control circuit 23 may read the plurality of risk assessment indicators corresponding to the physical unit 401(i) from the spare region 420 of the physical unit 401(i).

In an embodiment, the plurality of risk assessment indicators corresponding to the physical unit 401(i) may also be stored in at least one physical unit in the physical management unit 41. For example, the memory control circuit 23 may store the plurality of risk assessment indicators corresponding to the physical unit 401(i) in the first physical unit 401(1) or the last physical unit 401(D) in the physical management unit 41. Thereafter, when needed, the memory control circuit 23 may read the plurality of risk assessment indicators corresponding to the physical unit 401(i) from the first physical unit 401(1) or the last physical unit 401(D) in the physical management unit 41.

In an embodiment, the memory control circuit 23 may obtain the following parameters:
(1) Temperature Stress Integral, (2) Program/Erase time growth rate, (3) Voltage Calibration Count, (4) Bitline Leakage Level, and (5) Erase Verify Voltage (V_erase_verify). Each of the above will be described in turn below.
(1) Temperature stress integral may be configured to quantify the cumulative effect of temperature on charge leakage, involving the aging effect of temperature on the memory module 122. For example, under a sustained temperature environment, data stored in the first physical unit or the overall memory module 122 is susceptible to accelerated loss.

In an embodiment, the temperature of the memory module 122 may be sensed by a temperature sensor disposed in the storage device 12 and stored in the buffer memory 24 in the form of a temperature value. In an embodiment, the memory control circuit 23 may periodically read the temperature value of the memory module 122. For example, every 1 hour, 2 hours, or other time intervals, the memory control circuit 23 may re-read the latest temperature value of the memory module 122 from the buffer memory 24. Then, the memory control circuit 23 may bring the temperature value into an integration model to determine the temperature stress integral.

In an embodiment, the memory control circuit 23 may obtain the temperature stress integral according to the following formula (1.1).

$$TS = {\sum }_{k = 1}^{K} T ( k ) \qquad ( 1.1 )$$

In formula (1.1), TS represents the temperature stress integral, T(k) represents a temperature value read at the k-th time, and K is a total number of temperature values read. It should be noted that formula (1.1) may also be adjusted according to practical requirements.
(2) Program/Erase time growth rate may be configured to reflect a growth rate of the programming/erase time for the first physical unit within a time interval. For example, as the first physical unit or the overall memory module 122 ages, the program/erase time for the first physical unit each time will increase, thereby accelerating degradation of an oxide layer and affecting the quality of subsequent data access for the first physical unit.

In an embodiment, the memory control circuit 23 may determine the physical management unit (also referred to as the first physical management unit) to which the first physical unit belongs. Taking FIG. 4 as an example, all of the physical units 401(1) to 401(D) belong to the physical management unit 41. The memory control circuit 23 may obtain an average program/erase time of the first physical management unit. For example, an average program time of the first physical management unit may reflect an average of multiple program times measured after performing programming operations (also referred to as programmed operations) on at least one physical unit in the first physical management multiple times to store data. In addition, the average erase time of the first physical management unit may reflect an average of multiple erase times measured after performing erase operations (also referred to as erasure operations) on the first physical management multiple times. Then, the memory control circuit 23 may determine the program/erase time growth rate based on a difference between the average program/erase time and a preset program/erase time.

In an embodiment, the memory control circuit 23 may obtain the program/erase time growth rate according to the following formula (1.2).

$$G R = \frac{Δ T - T D}{T D} \times 100 \% \qquad ( 1.2 )$$

In formula (1.2), GR represents the program/erase time growth rate, ΔT represents the average program time or average erase time, and TD represents the preset program time or preset erase time. It should be noted that formula (1.2) may also be adjusted according to practical requirements.
(3) Voltage calibration count may reflect the number of initiations of the retry read operations for the first physical unit within a time interval.

In an embodiment, the memory control circuit 23 may monitor the number of the retry read operations for the first physical unit is initiated within a time interval or a count interval. For example, the time interval may be 1 hour or other time intervals. For example, after initiating the retry read operation for the first physical unit, the memory control circuit 23 may instruct the memory module 122 to perform a retry read operation on the first physical unit based on a retry read voltage, so as to attempt to read data with a relatively lower error rate and/or relatively higher reliability from the first physical unit. In particular, the retry read voltage used in the retry read operation needs to be different from a preset read voltage corresponding to the first physical unit. Then, the memory control circuit 23 may determine the voltage calibration count according to the number of initiations.

In an embodiment, the memory control circuit 23 may obtain the voltage calibration count according to the following formulas (1.31) and (1.32).

TR=TR+1 (1.31)

TF=TR×0.9 (1.32)

In formulas (1.31) and (1.32), TR represents the counted number of initiations of the re-read operations for the first physical unit, and TF represents the voltage calibration count. That is, each time a re-read operation for the first physical unit is initiated, the number of initiations is incremented by 1. In addition, by periodically (e.g., every hour or at other time intervals) attenuating (×0.9) the counted number of initiations (i.e., TR), the voltage calibration count may be made closer to the practice level. It should be noted that formulas (1.31) and (1.32) may also be adjusted according to practical requirements.
(4) Bitline leakage level may reflect an intensity of bitline leakage current. If the bitline leakage current intensity increases, it will directly lead to accelerated charge loss, thereby affecting data storage quality.

In an embodiment, the memory control circuit 23 may monitor a bitline charging time for the first physical unit during an access to the first physical unit. The bitline charging time may be negatively correlated with the intensity of the bitline leakage current of the first physical unit. Then, the memory control circuit 23 may determine the bitline leakage current level according to the bitline charging time.

In an embodiment, the memory control circuit 23 may obtain the bitline leakage current level according to the following formula (1.4).

BL=f(Tc) (1.4)

In formula (1.4), BL represents the bitline leakage current level, Tc represents the measured bitline charging time, and f( ) is a conversion function or a look-up table procedure. For example, in an embodiment, if Tc is less than 50 nanoseconds (ns), the represented bitline leakage current level may be level 3 (i.e., the highest bitline leakage current level, indicating severe leakage). If Tc is between 50 nanoseconds and 100 nanoseconds, the represented bitline leakage current level may be level 2 (i.e., the medium bitline leakage current level, indicating moderate leakage). If Tc is between 100 nanoseconds and 200 nanoseconds, the represented bitline leakage current level may be level 1 (i.e., the lowest bitline leakage current level, indicating minor leakage). It should be noted that formula (1.4) may also be adjusted according to practice requirements.
(5) Erase verify voltage may reflect a difference between a residual charge amount of the first physical management unit and a preset charge amount after performing an erase operation on the first physical management unit to which the first physical unit belongs. This erase verify voltage may reflect the wear of the first physical management unit.

In an embodiment, the memory control circuit 23 may obtain the erase verify voltage according to the following formula (1.5).

ΔVE=VC−VD (1.5)

In formula (1.5), ΔVE represents the erase verify voltage, VC represents the most recently measured residual charge amount of the first physical management unit, and VD represents the preset charge amount of the first physical management unit. It should be noted that formula (1.5) may also be adjusted according to practical requirements.

In an embodiment, the memory control circuit 23 may further obtain the following parameters: (6) a utilization count, (7) a read-disturb count, and (8) a data-retention time. Each of these will be described below.
(6) Utilization count may reflect the degree of use and/or degree of wear of the first physical unit (and/or the first physical management unit). For example, the utilization count may include a read count and an erase-write count. The read count may reflect the number of times a read operation is performed on the first physical unit and/or the first physical management unit. The erase-write count may reflect the number of times a programming operation and/or an erase operation is performed on the first physical unit and/or the first physical management unit. For example, as the degree of use and/or degree of wear of the first physical unit (and/or the first physical management unit) increases, the utilization count may increase correspondingly.
(7) Read-disturb count reflects the read disturb corresponding to the first physical unit. For example, the memory control circuit 23 may directly determine the read-disturb count based on the read count corresponding to the first physical unit. Alternatively, the memory control circuit 23 may count, within a period of time, the number of times or frequency that other physical units whose physical positions are adjacent to the first physical unit experience unexpected bit flips (or decoding failures) due to read disturb from the first physical unit. Then, the memory control circuit 23 may determine the read-disturb count based on the number of times or frequency.
(8) The data-retention time reflects a cumulative retention time of an item of data in the first physical unit. For example, the memory control circuit 23 may count a length of time elapsed after writing data into the first physical unit until a current time point or until the data is updated or erased. Then, the memory control circuit 23 may determine the data-retention time based on the length of time.

It should be noted that the aforementioned various parameters may also be adjusted, added, or reduced according to practical requirements, depending on the practical requirements.

In an embodiment, the memory control circuit 23 may obtain a plurality of risk assessment indicators corresponding to the first physical unit based on all or part of the aforementioned various parameters. Then, the memory control circuit 23 may dynamically determine or adjust the risk level of the first physical unit based on the risk assessment indicators. For example, the memory control circuit 23 may adjust or determine the risk level of the first physical unit to one of a plurality of candidate risk levels based on the plurality of risk assessment indicators corresponding to the first physical unit.

In an embodiment, the plurality of risk assessment indicators includes the erase-write count, the temperature stress integral, the bitline leakage current, the read count, the erase verify voltage, and a metadata error rate. Among these, the erase-write count, the temperature stress integral, the bitline leakage current, the read count, and the erase verify voltage have been described above and will not be repeated here. The metadata error rate may reflect a bit error rate of the first physical unit. For example, the metadata error rate may be positively correlated with the bit error rate of the first physical unit.

In an embodiment, the memory control circuit 23 may classify the plurality of risk assessment indicators to obtain a classification result. Based on the classification result, the memory control circuit 23 may input the plurality of risk assessment indicators into a multi-level arithmetic unit to perform classification processing on the plurality of risk assessment indicators and obtain a risk level assessment parameter.

In an embodiment, the multi-level arithmetic unit includes a plurality of arithmetic layers. In an embodiment, the arithmetic layers may include a core variable layer, a coupled variable layer, and a dynamic compensation layer. It should be noted that the core variable layer and the coupled variable layer may remain in a resident state (i.e., a constantly enabled state), while the dynamic compensation layer may be dynamically enabled or disabled based on the health and/or lifetime of the storage device 12.

In an embodiment, the memory control circuit 23 may input the erase-write count, the temperature stress integral, the bitline leakage current, and the read count into the core variable layer in the multi-level arithmetic unit for computation to obtain an assessment value (also referred to as a first assessment value). The memory control circuit 23 may input the erase verify voltage into the coupled variable layer in the multi-level arithmetic unit for computation to obtain another assessment value (also referred to as a second assessment value). The memory control circuit 23 may input the metadata error rate into the dynamic compensation layer in the multi-level arithmetic unit for computation to obtain yet another assessment value (also referred to as a third assessment value). Then, the memory control circuit 23 may obtain a risk level assessment parameter corresponding to the first physical unit based on the first assessment value, the second assessment value, and the third assessment value.

In an embodiment, the multi-level arithmetic unit may generate a risk level assessment parameter corresponding to the first physical unit based on the following formulas (2.1) to (2.6).

Q=W1×P1+W2×P2+W3×P3+W4×P4+W5×P5(2.1)

P1=1−(PEC/PEC max) (2.2)

P2=∫T(t)dt+λ*I_leak (2.3)

P3=1−RC/(β×BS/PS) (2.4)

P4=e\hat{ }{−|ΔV_erase−V0|/σ} (2.5)

P5=1/(1+RBER) (2.6)

In formula (2.1), Q is the risk level assessment parameter corresponding to the first physical unit. Q may be configured to quantify the health degree of the first physical unit. For example, the value of Q may be positively correlated with the health degree of the first physical unit. That is, the larger the value of Q, the healthier the first physical unit. In addition, W1 to W5 are weight parameters, which may be set according to practical requirements.

In formula (2.1) and (2.2), P1 is a normalized lifetime value for poor write, PEC is a program/erase count, and PECmax is a maximum program/erase count. P1 may be configured to reflect the wear degree of the first physical unit. For example, the smaller the value of P1 (i.e., closer to zero), the higher the wear degree of the first physical unit.

In formula (2.1) and (2.3), P2 is a temperature stress compensation value, and I_leak represents a bitline leakage current. P2 may be configured to integrate a temperature accumulation effect and a leakage current influence.

In formula (2.1) and (2.4), P3 is a read-disturb margin ratio, BS represents a size (e.g., represented by capacity) of the first physical management unit (or a physical block where the first physical unit is located), PS represents a size (e.g., represented by capacity) of the first physical unit, and β is a threshold coefficient. For example, the value of β may be set according to variable sensitivity. The lower the value of P3, the higher the read-disturb risk.

In formula (2.1) and (2.5), P4 is an erase verify voltage score, V0 is an initial offset reference, σ is a tolerance range (calibrated through aging test), in lieu of monitoring the program/erase (P/E) time growth rate, and ΔV_erase is an erase verify voltage. For example, a value of σ may be set according to a process node of the memory module 122.

In formula (2.1) and (2.6), P5 is an error-correction capability coefficient, and RBER is a raw data error rate. P5 may dynamically reflect the voltage calibration requirement, i.e., automatically lowering the score when RBER increases.

In an embodiment, in formula (2.1), W1×P1, W2×P2, and W3×P3 are performed in the core variable layer of the multi-level arithmetic unit, W4×P4 is performed in the coupled variable layer of the multi-level arithmetic unit, and W5×P5 is performed in the dynamic compensation layer of the multi-level arithmetic unit. In an embodiment, W1, W2, and W3 may be set to “0.7”, “0.2”, and “0.1” respectively (or other numerical combinations), to reflect the influence and/or importance of the core variable layer, the coupled variable layer, and the dynamic compensation layer on the overall output, respectively.

Conventional SSD health assessment models (such as S.M.A.R.T.) typically adopt a linear weighting approach (e.g., health=100%−worn percentage), which is difficult to reflect multi-parameter coupling effects (such as an accelerating effect of high temperature on P/E Cycle wear). The improved weighted average formula (i.e., the above formulas (2.1) to (2.6)) proposed by the present disclosure enhances the assessment accuracy and implementation efficiency of Q through the following mechanisms, including the following:

Hierarchical weight structure: core variables (P/E cycle, temperature, read count) account for 70%, prioritizing the monitoring accuracy of key parameters; nonlinear compensation terms: exponential functions (such as e^{-x}) are introduced to map physical stress (temperature, voltage offset), and implemented via lookup tables to avoid floating-point operations; dynamic feedback mechanism: a comparator is triggered based on a RBER threshold to respond in real time to NAND characteristic drift (such as degradation of an oxide layer), enhancing model adaptability; comprehensive risk factor modeling: the temperature stress compensation value implicitly includes the bitline leakage current effect, and the erase verify voltage score integrates the erase verify voltage and P/E time growth rate, comprehensively quantifying NAND risk.

Through the above formulas (2.1) to (2.6), while ensuring coverage of more than 90% of potential failure risks, the monitoring data collection and processing overhead may be reduced by approximately 70%, making it suitable for resource-constrained SSD firmware environments. It should be noted that the above formulas (2.1) to (2.6) may also be adjusted according to practical needs, and the present disclosure does not impose any limitation thereon.

In an embodiment, the dynamic compensation layer of the multi-level arithmetic unit may be enabled, as shown in formula (2.1). However, in an embodiment, the dynamic compensation layer of the multi-level arithmetic unit may be disabled, as shown in the following formula (3.1).

Q=W1×P1+W2×P2+W3×P3+W4×P4 (3.1)

It should be noted that in formula (3.1), since the RBER factor (i.e., the metadata error rate) is removed, the weight originally corresponding to the dynamic compensation layer may be redistributed to the core variables (and/or the coupled variable layer). This design may further simplify the computational load, but at the cost of losing the ability to respond to instantaneous bit error burst changes, which has little impact when the NAND health is relatively high.

In an embodiment, in the early lifetime of the storage device 12, the memory control circuit 23 may disable the dynamic compensation layer of the multi-level arithmetic unit. In addition, in the late lifetime of the storage device 12, the memory control circuit 23 may enable the dynamic compensation layer. For example, the memory control circuit 23 may evaluate whether the current storage device 12 is in the early lifetime or late lifetime through at least one of the parameters (1) to (8). For example, the memory control circuit 23 may obtain a lifetime evaluation value based on the parameters (1) to (8). This lifetime evaluation value may be positively correlated with the remaining lifetime of the storage device 12 and/or negatively correlated with the wear degree of the storage device 12. Therefore, if the lifetime evaluation value is greater than a lifetime threshold value, the memory control circuit 23 may determine that the current storage device 12 is in the early lifetime. Conversely, if the lifetime evaluation value is less than the lifetime threshold value, the memory control circuit 23 may determine that the current storage device 12 is in the late lifetime.

In an embodiment, the memory control circuit 23 may further determine whether to enable or disable the dynamic compensation layer of the multi-level arithmetic unit based on the type of the storage device 12 (e.g., model number and/or whether it is an enterprise-level storage device, etc.). For example, if the type of the storage device 12 is a specific type (e.g., specific model number and/or an enterprise-level storage device) (also referred to as a first type), the memory control circuit 23 may enable the dynamic compensation layer of the multi-level arithmetic unit. However, if the type of the storage device 12 is another type (e.g., other model numbers and/or not an enterprise-level storage device) (also referred to as a second type), the memory control circuit 23 may disable the dynamic compensation layer of the multi-level arithmetic unit. In addition, the related operations of enabling or disabling the dynamic compensation layer of the multi-level arithmetic unit may also be managed in conjunction with the lifetime of the storage device 12, thereby further improving control precision.

In an embodiment, after obtaining the risk level assessment parameter (e.g., Q) corresponding to the first physical unit, the memory control circuit 23 may compare the risk level assessment parameter with at least one threshold value to obtain a comparison result. Based on the comparison result, the memory control circuit 23 may determine or adjust the risk level of the first physical unit.

For example, if the risk level assessment parameter (e.g., Q) is greater than a threshold value (also referred to as a first threshold value, e.g., “0.8”), the memory control circuit 23 may determine that the risk level of the first physical unit is a specific risk level (also referred to as a first risk level) among the multiple candidate risk levels. Or, if the risk level assessment parameter (e.g., Q) is between the first threshold value and another threshold value (also referred to as a second threshold value, e.g., “0.5”), the memory control circuit 23 may determine that the risk level of the first physical unit is another risk level among the multiple candidate risk levels (also referred to as a second risk level). Or, if the risk level assessment parameter (e.g., Q) is less than the second threshold value, the memory control circuit 23 may determine that the risk level of the first physical unit is yet another risk level (also referred to as a third risk level) among the multiple candidate risk levels.

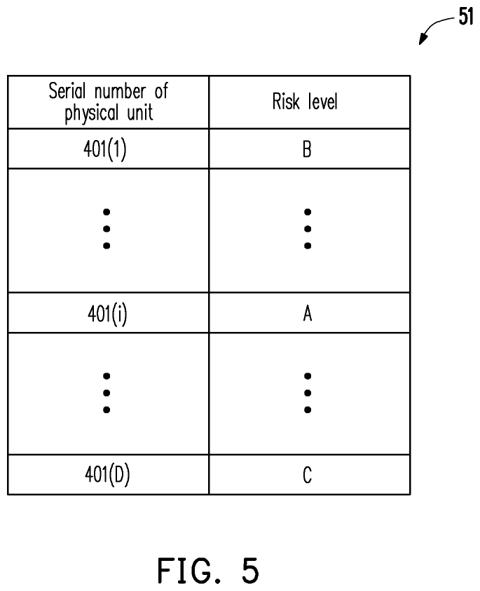

FIG. 5 is a schematic diagram illustrating the respective risk levels of different physical units according to an embodiment of the present disclosure. Please refer to FIG. 5, in an embodiment, after determining the risk level of the first physical unit, the memory control circuit 23 may record the risk level information corresponding to the first physical unit in a management table 51. The risk level information may reflect the risk level of the first physical unit.

For example, the management table 51 may be configured to record the risk level information respectively corresponding to the physical units 401(1) to 401(D). For example, the risk level information corresponding to the physical unit 401(1) may reflect that the risk level of the physical unit 401(1) is a risk level B. The risk level information corresponding to the physical unit 401(i) may reflect that the risk level of the physical unit 401(i) is a risk level A. The risk level information corresponding to the physical unit 401(D) may reflect that the risk level of the physical unit 401(D) is a risk level C.

In an embodiment, the memory control circuit 23 may also record the risk level information corresponding to the first physical unit in the spare region of the first physical unit. Taking FIG. 4 as an example, the memory control circuit 23 may record the risk level information corresponding to the physical unit 401(i) in the spare region 420 in the physical unit 401(i). Thereafter, the memory control circuit 23 may read the risk level information from the spare region 420 and determine the risk level (e.g., risk level A) of the first physical unit based on the risk level information.

In an embodiment, if the risk level of the first physical unit is the first risk level (e.g., Q is greater than the first threshold value), the memory control circuit 23 may operate the first physical unit based on a conventional operation mode. For example, the conventional operation mode refers to a preset operation mode for all (or most) physical units in the first physical unit or the memory module 122. For example, in the conventional operation mode, the memory control circuit 23 may perform a conventional read on the first physical unit based on a preset read voltage to read data from the first physical unit.

In an embodiment, in the conventional operation mode, after data is read from the first physical unit, the accuracy of the data may be confirmed first. If the data includes errors, the decoding circuit 25 may perform a decoding operation on the data to attempt to correct the errors in the data. If all errors in the data are successfully corrected, the corrected data may be transmitted to the host system 11 in response to a read instruction from the host system 11, or used for internal data organization (e.g., garbage collection or wear leveling, etc.) of the storage device 12. However, if all errors in the data cannot be successfully corrected, a re-read operation for the first physical unit may be initiated (or triggered) to perform a re-read operation on the first physical unit based on a re-read voltage. In particular, the re-read voltage may be different from the preset read voltage used for the conventional read.

In an embodiment, if the risk level of the first physical unit is the second risk level (e.g., Q is between the first threshold value and the second threshold value), when reading data from the first physical unit, the memory control circuit 23 may directly perform a re-read operation on the first physical unit based on the re-read voltage without performing decoding on the data through the decoding circuit 25 (i.e., skipping the conventional read on the first physical unit). That is, compared to the conventional operation mode, when reading data from the first physical unit, the conventional read of the first physical unit and the decoding operation on the data may be skipped, and the re-read operation for the first physical unit may be directly initiated.

In an embodiment, if the risk level of the first physical unit is the third risk level (e.g., Q is less than the second threshold value), the memory control circuit 23 may trigger data migration and service blocking for the first physical unit. For example, after triggering data migration for the first physical unit, the memory control circuit 23 may copy or move the valid data currently stored in the first physical unit to another physical unit for storage. For example, the data migration may include internal data organization procedures of the storage device 12 such as garbage collection or wear leveling. In addition, after triggering service blocking for the first physical unit, the memory control circuit 23 may mark the first physical unit as no longer in use, but data may still be read from the first physical unit.

In other words, if physical units are ranked by health level, physical units belonging to the first risk level have the highest health level, physical units belonging to the third risk level have the lowest health level, and physical units belonging to the second risk level have a health level between the two. In an embodiment, the number of the candidate risk levels may also be increased or decreased according to practical needs.

In an embodiment, in the service blocking of the first physical unit, the memory control circuit 23 may further fill the first physical unit with formatted data and mark the first physical unit as no longer in use. For example, the formatted data may include a plurality of “0”s or other preset strings. Thereby, the first physical unit may be further prevented from being accidentally used subsequently.

In an embodiment, the memory control circuit 23 may detect whether the current storage device 12 (or memory module 122) is in a free state. When the storage device 12 (or memory module 122) is in a free state, the memory control circuit 23 may proactively perform the data migration on at least one physical unit (also referred to as a second physical unit) in the memory module 122 whose risk level is the third risk level. Thereby, after the user begins operating the storage device 12 (e.g., storing data into the storage device 12 or reading data from the storage device 12), without the user's awareness, the memory control circuit 23 has actually completed the data movement within the memory module 122, risk management of physical units, and/or access control of physical units, so as to improve the operational stability of the storage device 12. However, if the storage device 12 is not in a free state, the memory control circuit 23 may not proactively perform the data migration.

In an embodiment, when the storage device 12 is in a free state, the memory control circuit 23 may further proactively scan at least one physical unit (also referred to as a third physical unit) in the memory module 122 belonging to a system region, so as to determine the risk level of these physical units (i.e., the third physical units). In particular, the physical units (i.e., the third physical units) in the memory module 122 belonging to the system region may be dedicated to storing system data. For example, the system data may include various management tables such as a logical-to-physical mapping table, a valid count management table, a bad block management table, and/or a log table. However, if the storage device 12 is not in a free state, the memory control circuit 23 may not perform the proactive scanning.

In an embodiment, when the storage device 12 is in a free state, the memory control circuit 23 may further proactively scan at least one physical unit (also referred to as a fourth physical unit) in the memory module 122, so as to determine the risk level of the fourth physical unit. In particular, the access frequency corresponding to the fourth physical unit is lower than a frequency threshold. That is, when the storage device 12 is in a free state, the memory control circuit 23 may proactively scan the physical units (i.e., the fourth physical units) in the memory module 122 currently configured to store cold data, so as to determine the risk level (or health degree) of the physical units (i.e., the fourth physical units) currently configured to store cold data. In an embodiment, after determining the risk level of the first physical unit (and the remaining physical units in the memory module 122), the memory control circuit 23 may establish a health map based on the risk level of each physical unit. The health map may reflect the health degree of at least some physical units in the memory module 122, and may be configured to search for or confirm physical units in the memory module 122 having a specific health degree (or a specific risk level). Thereafter, when the storage device 12 is in a free state, the memory control circuit 23 may further perform a predetermined operation on at least one physical unit in the memory module 122 based on the health map. For example, the predetermined operation may include the data migration and/or the proactive scanning, and the predetermined operation may further include any operation that helps improve the operational performance and/or stability of the storage device 12, which will not be elaborated one by one here.

In an embodiment, during the process in which the memory control circuit 23 performs data migration or proactive scanning on the first physical unit, the memory control circuit 23 may evaluate the risk level (including obtaining the risk level assessment parameters (e.g., Q)) of the first physical unit based on the multiple parameters and/or risk assessment indicators. If the risk level of the first physical unit is assessed as a first risk level (e.g., a “green” level), in subsequent conventional read operations on the first physical unit, using the preset read voltage corresponding to the first physical unit to read data from the first physical unit will have a high probability of successfully completing the decoding of the data, thereby eliminating unnecessary re-read processes and time.

Alternatively, if the risk level of the first physical unit is assessed as a second risk level (e.g., a “yellow” level), it indicates that the memory control circuit 23 determines that the first physical unit is a physical unit with risk. Thereafter, when reading data from the first physical unit, the memory control circuit 23 may skip performing the conventional read on the first physical unit, and directly perform a re-read operation on the first physical unit based on a re-read voltage. By using the adjusted read voltage in the re-read operation to read data from the first physical unit, the decoding success rate of the re-read data may be effectively improved. Thus, for physical units having the second risk level (e.g., a “yellow” level), at least one read of dirty data in the physical unit and subsequent processing (e.g., decoding with a high probability of failure) may be reduced, thereby effectively improving data read efficiency.

Furthermore, if the risk level of the first physical unit is assessed as a third risk level (e.g., a “red” level), it indicates that the memory control circuit 23 determines that the first physical unit is a high risk physical unit. In this case, the memory control circuit 23 may directly mark the first physical unit as operating in a read-only mode. In the read-only mode, new data cannot be written into the first physical unit, but old data may be read from the first physical unit (e.g., migrating the old data to other physical units with a higher health degree).

Furthermore, when the present disclosure is applied to UFS (Universal Flash Storage) album-access or game-loading operations, by way of example, the background is as follows: a user rapidly scrolls through high-resolution photos or videos, or loads large-scale games/applications; the storage subsystem is subjected to an intensive sequential read workload; and the device is sensitive to power consumption and heat generation. Conventional shortcomings include: some photo/application data blocks that have been retained for an extended period or have undergone numerous write/program cycles may exhibit substantial threshold-voltage shift; conventional solutions initiate retries only upon encountering read errors, resulting in perceptible stutter during image/application loading; and repeated retries and data transfers increase the power consumption of the system-on-chip (SoC) and the storage, thereby causing device heating.

In accordance with the present disclosure, upon a user-initiated continuous read request (e.g., loading an image stream), the memory control circuit 23 evaluates, in parallel and/or on a prefetch basis, the Q-value of pages scheduled for imminent read access. For “green” pages, a standard read is performed, resulting in smooth loading. For “yellow” pages, before data exits the flash memory chip, the controller promptly performs a re-read using voltages optimized for that page and/or derived from the historical characteristics of adjacent pages/blocks. The user may perceive only a minimal loading delay, rather than any noticeable stutter. This approach avoids the substantial latency that would otherwise result from forwarding raw erroneous data to the memory control circuit 23 for subsequent processing. For “red” pages, because the block has been proactively designated as read-only and may have been migrated by garbage collection (GC), a user is unlikely to encounter read-failure errors when accessing commonly used data (e.g., recent photographs). High-risk blocks are handled unobtrusively by the system in the background.

When applied in a UFS system, the present disclosure enables retries for “yellow” pages to be completed rapidly within the flash memory, such that the user's seamless experience is not affected and perceptible stuttering is eliminated. It avoids the off-chip transfer of large volumes of invalid data and repeated attempts at off-chip ECC decoding, thereby reducing system power consumption and heat generation. By proactively managing high-risk blocks, it reduces the likelihood that users encounter a “file corrupted” prompt and enhances device reliability.

By way of example, the present disclosure is applied to eMMC log storage in an industrial Internet of Things (IoT) gateway. Background: the industrial gateway continuously writes sensor data logs to eMMC. The device may operate in harsh environments, including high temperature, high humidity, or vibration. Stringent data-reliability requirements apply, and maintenance is difficult.

Conventional shortcomings include: Harsh environments accelerate the aging of flash memory cells and the drift of threshold voltages. When historical logs are retrieved for analysis, the read-failure rate for older data is high. Conventional read-retry procedures are time-consuming and may result in query timeouts or sluggish system responses. Frequent failed retries and potential unrecoverable errors increase maintenance requirements.

In accordance with the present disclosure, when the gateway is free or under low load, a background task of the memory control circuit 23 may proactively scan stored log blocks, compute the Q-values of their data pages, and establish a health map. For blocks/pages identified as “yellow” by the scan, the system may, during the next free period, proactively trigger a data refresh (read-error-correcting code (ECC) correction-write to a new location) as a preventive measure, thereby avoiding failures that would otherwise occur only upon a read attempt. For blocks identified as “red,” the system shall immediately mark them as read-only and refresh them on a high-priority basis, thereby ensuring that, when critical logs must be read, the data remains safely accessible. Consequently, when the application actually needs to read logs, the likelihood of encountering a retry (“yellow”) is greatly reduced; and even if a retry is encountered, a fast internal retry within the flash memory may shorten access time.

In eMMC applications, the present disclosure, when deployed in harsh environments, through proactive health management, substantially increases the probability of successfully reading historical data, thereby ensuring the readability of critical data. It reduces query timeouts or system errors caused by failures to read old logs, thereby improving system availability. It detects and isolates high-risk blocks in advance, reduces field failure rates, and lowers maintenance costs. A health map guides refresh operations in a more targeted manner, processing only blocks that are actually at risk, thereby optimizing the efficiency of background tasks.

The present disclosure is further applied to USB flash drives, as USB flash drives are subject to frequent insertion/removal and the need to read cold data.

Background: USB flash drives are frequently inserted and removed across different computers and are used to store documents, photographs, and the like. After data is written, it may remain unread for extended periods (cold data). High compatibility is required. Conventional shortcomings include that cold data is prone to charge leakage, resulting in threshold voltage drift. When a user attempts, on a particular computer, to read a file that has not been opened for a long time, the user may encounter slow reads (repeated retries) or even failures (“file corrupted”). Differences in voltage stability among host controllers and USB interfaces may exacerbate read issues.

Based on the present disclosure, the memory control circuit 23, during free periods (e.g., immediately after insertion before any operation) or in the background, may perform sampled Q-value evaluation on key blocks in the metadata region or on blocks associated with the file allocation table, or on blocks known to have been stored for a long time. Upon detecting a “yellow” block/page: prior to the next access to that block, or during background free time, the controller proactively attempts to read at optimized voltages and perform a refresh (if supported), or at least records optimized voltage parameters for rapid application at the time of actual reading. Upon detecting a “red” block: the controller marks it read-only and isolates it through the file system (e.g., FAT bad-cluster marking) or through an internal mapping table of the USB flash drive firmware. The controller reports a read error to the host (rather than failing only when the user attempts to open the file), or attempts background migration of recoverable data (if supported by the design). When a user reads a file and the target page is “yellow,” the controller utilizes previously obtained assessment information or performs rapid internal retries, thereby greatly reducing the user's perceived stall time.

When applied to USB flash drives, the present disclosure reduces the likelihood that users experience slow or failed file openings, enhances product reputation, and improves the user experience. It proactively identifies and handles high-risk cold data to increase data reliability. By performing read-voltage optimization within the device, it reduces dependence on the stability of disparate host controllers, thereby improving compatibility.

The present disclosure is further applicable to high-capacity archival reads of QLC SSDs at end of life. Background: QLC SSDs provide high capacity at low cost and are commonly used for warm/cold data storage. As they approach their program/erase cycle limit, cell stability degrades and the raw bit error rate (RBER) increases significantly.

Conventional shortcomings include the following: when reading archival data, failure rates and retry counts surge, causing a precipitous collapse in read performance. Substantial time is wasted on transmitting and decoding raw data that is almost certain to fail or to require multiple retries. Effective bandwidth drops sharply, resulting in a poor user experience.

The memory control circuit 23 relies heavily on a Q-score to manage read operations. Health assessment becomes part of the standard process. Pages may be classified, for example, as: Green pages: standard reads (their proportion will decrease); Yellow pages: become the norm; the core advantages of the algorithm are maximally realized here. The memory control circuit 23 must efficiently leverage historical information, neighboring-page information, block-level statistics, and the like to rapidly identify an optimal or near-optimal read voltage; complete read-retry attempts on-die; and output only the data version most likely to decode successfully. This avoids the suffocating consumption of bandwidth by massive transfers of invalid raw data. Red pages: their proportion increases significantly. The system must aggressively mark pages or blocks as read-only and perform garbage collection. Read requests should, to the extent practicable, be redirected to refreshed copies. For red pages that must be read, more sophisticated recovery mechanisms may be required (e.g., RAIN, in conjunction with LDPC iterative decoding), but the algorithm at least provides early warning and avoids unnecessary initial data transmission.

For QLC SSDs at end of life, application of the present disclosure under extremely high RBER conditions avoids invalid data transfers and performs rapid on-die optimization, thereby maximizing usable read bandwidth and flattening the performance degradation curve, i.e., maintaining usable read performance. High-risk blocks are managed with greater precision to prevent sporadic errors from rendering an entire device or dataset unavailable, thereby extending usable service life. High-risk data are explicitly flagged, affording the system or an administrator an opportunity to intervene for data migration or backup, ensuring continued data accessibility.

In summary, based on the present disclosure, the approach shifts from “remediate after a read failure” to “pre-assess health prior to reading,” thereby moving from a reactive to a proactive paradigm. Critical health assessment and preliminary retry decision-making are performed within the flash memory, thereby avoiding unnecessary off-chip data transfers (tDMA). This is key to conserving bandwidth. Only data from “green” pages and optimized data from “yellow” pages are transferred, completely avoiding the transfer of raw data with high bit error rates (the principal cause of bandwidth waste in conventional solutions). The effective channel bandwidth is substantially increased. Superfluous tR (read time)+tDMA (off-chip data transfer time)+tECC (decoding time) cycles and procedures are avoided (for ultimately successful green pages and a portion of yellow pages). For yellow pages requiring retry, the retry process (tR) is also completed more efficiently on-chip, thereby reducing overall read latency (particularly tail latency). Ineffectual decoding attempts (tECC) by the off-chip ECC engine are reduced, lowering the CPU load and power consumption of memory control circuit 23. By proactively identifying high-risk blocks (red) through a Q score, garbage collection is prioritized or the blocks are marked read-only, thereby preventing data loss and improving overall product reliability and service life.

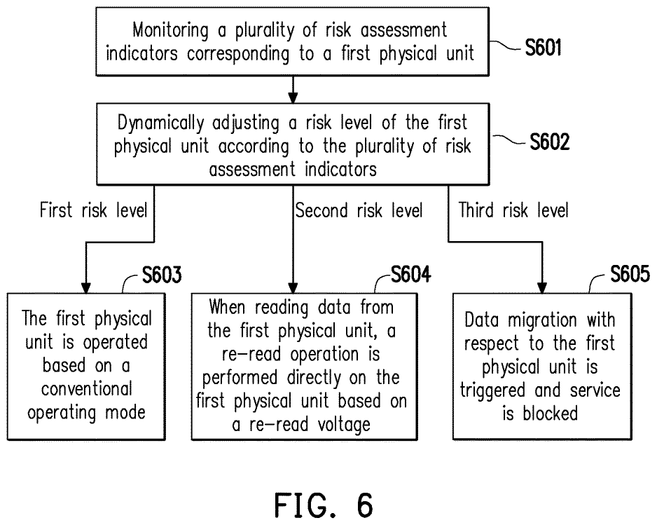

FIG. 6 is a flowchart illustrating a memory management method according to an embodiment of the present disclosure. Referring to FIG. 6, in step S601, a plurality of risk assessment metrics corresponding to a first physical unit are monitored. In step S602, a risk level of the first physical unit is dynamically adjusted based on the plurality of risk assessment metrics. If the risk level of the first physical unit is a first risk level, then in step S603 the first physical unit is operated based on a conventional operating mode. If the risk level of the first physical unit is a second risk level, then in step S604, when reading data from the first physical unit, a re-read operation is performed directly on the first physical unit based on a re-read voltage, wherein the re-read voltage is different from a preset read voltage corresponding to the first physical unit. If the risk level of the first physical unit is a third risk level, then in step S605, data migration with respect to the first physical unit is triggered and service is blocked (i.e., disabled).

As the steps in FIG. 6 have been described in detail above, further description thereof is omitted here. It should be noted that the steps in FIG. 6 may be implemented as multiple program codes or circuits, and the present disclosure is not limited thereto. In addition, the method of FIG. 6 may be used in conjunction with the foregoing exemplary embodiments or used independently; the present disclosure is not limited in this regard.

In sum, the memory management method and storage device proposed in the embodiments of the present disclosure may determine the latest risk level of each physical unit in a memory module based on multiple risk assessment metrics and may then dynamically adjust the corresponding management strategy according to the latest risk level of each physical unit, such as operating a particular physical unit based on a conventional operating mode, performing a re-read operation directly on the particular physical unit based on a re-read voltage when reading data therefrom, or triggering data migration and service blocking for the particular physical unit. As a result, the operational stability of the storage device may be effectively improved.

Finally, it should be noted that the foregoing embodiments are intended to illustrate, rather than limit, the technical solutions of the present disclosure. Although the present disclosure has been described in detail with reference to the foregoing embodiments, those of ordinary skill in the art will understand that they may still modify the technical solutions described in the foregoing embodiments, or make equivalent substitutions for some or all of the technical features therein. Such modifications or substitutions do not cause the essence of the corresponding technical solutions to depart from the scope of the technical solutions of the embodiments of the present disclosure.

What is claimed is:

1. A memory management method for a storage device, wherein the storage device comprises a memory module, the memory module comprises a plurality of physical units, and the memory management method comprises:
monitoring a plurality of risk assessment indicators corresponding to a first physical unit among the plurality of physical units;
dynamically adjusting a risk level of the first physical unit according to the plurality of risk assessment indicators; and
if the risk level is a second risk level, when reading data from the first physical unit, skipping performing a conventional read on the first physical unit, and directly performing a re-read operation on the first physical unit based on a re-read voltage, wherein the re-read voltage is different from a preset read voltage used for the conventional read.

2. The memory management method according to claim 1, further comprising:
if the risk level is a first risk level, operating the first physical unit based on a conventional operation mode; and
if the risk level is a third risk level, triggering data migration and service blocking for the first physical unit.

3. The memory management method according to claim 1, wherein the step of dynamically adjusting the risk level of the first physical unit according to the plurality of risk assessment indicators comprises:
obtaining a classification result based on a classification of the plurality of risk assessment indicators;
bringing the plurality of risk assessment indicators into a multi-level arithmetic unit based on the classification result to perform classification processing on the plurality of risk assessment indicators and obtain a risk level assessment parameter; and
determining the risk level of the first physical unit based on the risk level assessment parameter.

4. The memory management method according to claim 3, wherein the plurality of risk assessment indicators comprise:
an erase-write count, a temperature stress integral, a bitline leakage current, a read count, an erase verify voltage, and a metadata error rate.

5. The memory management method according to claim 4, wherein the multi-level arithmetic unit comprises a plurality of arithmetic layers, and the step of bringing the plurality of risk assessment indicators into the multi-level arithmetic unit according to the classification result to perform the classification processing on the plurality of risk assessment indicators and obtain the risk level assessment parameter comprises:
bringing the erase-write count, the temperature stress integral, the bitline leakage current, and the read count into a core variable layer among the plurality of arithmetic layers to obtain a first assessment value;
bringing the erase verify voltage into a coupled variable layer among the plurality of arithmetic layers to obtain a second assessment value;
bringing the metadata error rate into a dynamic compensation layer among the plurality of arithmetic layers to obtain a third assessment value; and
obtaining the risk level assessment parameter based on the first assessment value, the second assessment value, and the third assessment value.

6. The memory management method according to claim 5, further comprising:
in an early lifetime of the storage device, disabling the dynamic compensation layer; and
in a late lifetime of the storage device, enabling the dynamic compensation layer.

7. The memory management method according to claim 1, further comprising:
when the storage device is in a free state, proactively performing data migration on a second physical unit among the plurality of physical units whose risk level is a third risk level.

8. The memory management method according to claim 1, further comprising:
when the storage device is in a free state, proactively scanning a third physical unit among the plurality of physical units that belongs to a system region to determine a risk level of the third physical unit, wherein the third physical unit belonging to the system region is configured to store system data.

9. The memory management method according to claim 1, further comprising:
after determining the risk level of the first physical unit, establishing a health map according to the risk level; and
when the storage device is in a free state, performing a predetermined operation on at least one of the plurality of physical units according to the health map.

10. The memory management method according to claim 1, further comprising:
when the storage device is in a free state, proactively scanning a fourth physical unit among the plurality of physical units for storing specific data to determine a risk level of the fourth physical unit, wherein an access frequency corresponding to the fourth physical unit is lower than a frequency threshold value.

11. A storage device, comprising:
a connection interface, configured to connect to a host system;
a memory module; and
a memory controller, connected to the connection interface and the memory module,
wherein the memory module comprises a plurality of physical units, and the memory controller is configured to:
monitor a plurality of risk assessment indicators corresponding to a first physical unit among the plurality of physical units;
dynamically adjust a risk level of the first physical unit according to the plurality of risk assessment indicators; and
if the risk level is a second risk level, when reading data from the first physical unit, skip performing a conventional read on the first physical unit, and directly perform a re-read operation on the first physical unit based on a re-read voltage, wherein the re-read voltage is different from a preset read voltage used for the conventional read.

12. The storage device according to claim 11, wherein the memory controller is further configured to:
if the risk level is a first risk level, operate the first physical unit based on a conventional operation mode; and
if the risk level is a third risk level, trigger data migration and service blocking for the first physical unit.

13. The storage device according to claim 11, wherein the operation of dynamically adjusting the risk level of the first physical unit according to the plurality of risk assessment indicators comprises:
obtaining a classification result based on a classification of the plurality of risk assessment indicators;
bringing the plurality of risk assessment indicators into a multi-level arithmetic unit based on the classification result to perform classification processing on the plurality of risk assessment indicators and obtain a risk level assessment parameter; and
determining the risk level of the first physical unit based on the risk level assessment parameter.

14. The storage device according to claim 13, wherein the plurality of risk assessment indicators comprise:
an erase-write count, a temperature stress integral, a bitline leakage current, a read count, an erase verify voltage, and a metadata error rate.

15. The storage device according to claim 14, wherein the multi-level arithmetic unit comprises a plurality of arithmetic layers, and the operation of bringing the plurality of risk assessment indicators into the multi-level arithmetic unit according to the classification result to perform the classification processing on the plurality of risk assessment indicators and obtain the risk level assessment parameter comprises:
bringing the erase-write count, the temperature stress integral, the bitline leakage current, and the read count into a core variable layer among the plurality of arithmetic layers to obtain a first assessment value;
bringing the erase verify voltage into a coupled variable layer among the plurality of arithmetic layers to obtain a second assessment value;
bringing the metadata error rate into a dynamic compensation layer among the plurality of arithmetic layers to obtain a third assessment value; and
obtaining the risk level assessment parameter based on the first assessment value, the second assessment value, and the third assessment value.

16. The storage device according to claim 15, wherein the memory controller is further configured to:
in an early lifetime of the storage device, disable the dynamic compensation layer; and
in a late lifetime of the storage device, enable the dynamic compensation layer.

17. The storage device according to claim 11, wherein the memory controller is further configured to:
when the storage device is in a free state, proactively perform data migration on a second physical unit among the plurality of physical units whose risk level is a third risk level.

18. The storage device according to claim 11, wherein the memory controller is further configured to:
when the storage device is in a free state, proactively scan a third physical unit among the plurality of physical units that belongs to a system region to determine a risk level of the third physical unit, wherein the third physical unit belonging to the system region is configured to store system data.

19. The storage device according to claim 11, wherein the memory controller is further configured to:
after determining the risk level of the first physical unit, establish a health map according to the risk level; and
when the storage device is in a free state, perform a predetermined operation on at least one of the plurality of physical units according to the health map.

20. The storage device according to claim 11, wherein the memory controller is further configured to:
when the storage device is in a free state, proactively scan a fourth physical unit among the plurality of physical units for storing specific data to determine a risk level of the fourth physical unit, wherein an access frequency corresponding to the fourth physical unit is lower than a frequency threshold value.
